(19) United States
(12) Patent Application Publication
(10) Pub. No.: US 2022/0097462 A1
(43) Pub. Date: Mar. 31, 2022

(54) PAD FOR PREVENTING TIRE SKIDDING AND MANUFACTURING METHOD THEREOF

(71) Applicant: SNOWBEAR. CO., LTD., Gwangju (KR)

(72) Inventors: Seung Hoon KIM, Gwangju (KR); Jeong Seon BAEK, Gwangju (KR)

(21) Appl. No.: 17/034,396

(22) Filed: Sep. 28, 2020

(51) Int. Cl. B60C 11/18; C08K 3/36; C08K 3/04; C08L 9/00; B29B 7/74; B29B 7/88; C08K 3/06; B29C 35/02; B29C 70/88; B29C 70/82; C09J 7/24; C09J 133/14

(52) U.S. Cl. CPC B60C 11/18; C08K 3/36; C08K 3/04; C08L 9/00; B29B 7/7495; B29B 7/88; B29K 2009/00; B29C 35/02; B29C 70/885; B29C 70/82; C09J 7/241; C09J 133/14; C08K 3/06

(57) ABSTRACT

A pad for preventing tire skidding and a manufacturing method thereof, and is to provide a pad for preventing tire skidding and a manufacturing method thereof configured by a friction member formed by mixing a raw material rubber containing butadiene rubber and a functional additive; an adhesive layer coated with an adhesive on one side of the friction member so that the friction member is able to be adhered to a vehicle tire; and a mesh net embedded in the friction member or a mesh net connected to a piezoelectric element. The pad is provided with an adhesive layer coated with an adhesive and can be easily attached and used onto a vehicle tire, and is made of a large amount of butadiene rubber to increase the friction force against the ground.

### BACKGROUND

The present invention relates to a pad for preventing tire skidding and a manufacturing method thereof, and more particularly, to a pad for preventing tire skidding and a manufacturing method thereof, in which a large amount of butadiene rubber is used to be attached to a vehicle tire and increase a friction force against the ground in winter, a mesh net is embedded to improve durability, and further, the mesh net is coupled to supply power and acts as a hot wire to prevent cooling.

In general, tires used on wheels of a vehicle rotate the wheels through friction with a road surface to allow the vehicle to be driven, and even when the driving vehicle is stopped or the speed is reduced, if a brake system of the vehicle is operated, a large frictional resistance is generated between the tire and the road surface, thereby stopping the vehicle or reducing the speed.

However, if the frictional resistance between the tire and the road surface is set to be large in consideration of only the braking, the fuel consumption increases and thus, the fuel economy decreases. Accordingly, the tire has been designed in consideration of the vehicle speed and the shape of the road surface.

On the other hand, when the vehicle is driven on a road where the road surface is wet due to rain or the road surface is covered with sand, a coefficient of friction between the road surface and the tire decreases due to the rain or sand, so that the tire cannot rotate against the road surface and skid.

If this phenomenon is continued while driving, the vehicle cannot speed up and spins in place, and if such a phenomenon occurs during braking of the vehicle driving at high speed, the braking is not properly applied, resulting in increasing a possibility of a major accident.

Considering a case of a safety problem while driving the vehicle, there is also a problem even when it rains or the sand is covered on the road as described above, but a bigger problem occurs after snow falls. In other words, when the snow falls and accumulates on the road surface, or when the snow is melted and frozen to be iced on the road surface, it becomes very weak so that there is little friction with the tire, and thus, the vehicle skids so that the normal driving is difficult, and the vehicle is not properly braked to cause frequent accidents.

To prevent traffic accidents caused by skidding while the vehicle is driving on a snowy road or an icy road in winter, various methods have been proposed and practiced, such as mounting snow-only tires on the vehicle, using a snow chain equipped to cover an outer peripheral surface of the tire, or spraying an anti-skid agent prepared in a spray form on the surface of the tire to increase the friction coefficient.

Products in the form of binding to wrap tires using metal chains, and products in which nuts or urethane members are installed on the outside of a wire make up the main part of snow chains which have been used in the related art. These conventional snow chains have been widely used to relatively increase the braking power of vehicles, but due to the hardness and weight thereof, there is a problem in that the snow chains cause damage to the tire itself and damage to the road surface, and there is also a problem in that the road surface and the chains collide with each other, causing loud noise or vibration and it is not good in terms of aesthetics.

In addition, the conventional snow chains are configured by binding the chains so as to form two rows corresponding to the width of the tire and be arranged at a predetermined interval therebetween. Since the snow chains are fastened to cover the wheels of the vehicle to fix both ends and fix the outer side of the tire to be radially woven with an elastic string, there is a problem in that an operation for attaching and detaching the chains is very cumbersome and a lot of time is required. In addition, since there is a case where separate equipment is required when attaching and detaching the chains, there is a problem in that the operation is very difficult and inconvenient.

Even if the snow chain is mounted on the tire through the above process, when the mounting condition is not solid but loose, the installed chain is often detached while driving or the chain is broken, making it impossible to reuse, and the broken chain may cause damage to other vehicles.

### PRIOR ART DOCUMENT

Korean Laid-open Utility Model Publication No. 20-1999-012626 “SNOW CHAIN FOR VEHICLES”

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art and to a pad for preventing tire skidding and a manufacturing method thereof. An object of the present invention is to provide a pad for preventing tire skidding in which an adhesive layer is provided to be attached to a tire and a large amount of butadiene rubber is made to increase a friction force against the ground.

Further, an object of the present invention is to provide a pad for preventing tire skidding capable of minimizing the pad from tearing when removing the pad from a tire, thereby improving removal convenience.

In addition, an object of the present invention is to provide a pad for preventing tire skidding capable of preventing hardness from cooling of a friction member by embedding a hot wire.

According to the present invention to achieve the objects, there is provided a pad for preventing tire skidding comprising: a friction member formed by mixing a raw material rubber containing 80 wt % or more of butadiene rubber and a functional additive consisting of silica, carbon black, an adhesive, and stud powder; and an adhesive layer coated with an adhesive on one side of the friction member so that the friction member is able to be adhered to a vehicle tire.

Further, the present invention is solved by providing a pad for preventing tire skidding in which a mesh net is embedded in a friction member to minimize the pad from tearing when removing the pad from the tire.

Further, the present invention is solved by providing the pad for preventing tire skidding further comprising a piezoelectric element connected to the mesh net embedded in the friction member to supply power, wherein when the piezoelectric element is pressed, the power may be supplied to the mesh net and may be used as a hot wire to prevent the hardness from cooling of the friction member.

Further, the present invention is solved by providing a manufacturing method of a pad for preventing tire skidding comprising: a peptizing step of peptizing a raw material rubber containing butadiene rubber at a predetermined temperature; a first mixing step of kneading the raw material rubber and a functional additive using a kneader, after the peptizing step; a dumping step of dumping a first mixture in which the raw material rubber and the functional additive are kneaded through the first mixing step from the kneader and leaving and stabilizing the dumped first mixture at room temperature for a predetermined time; a second mixing step of kneading sulfur into the first mixture, after the dumping step; a cutting step of cutting a second mixture in which the first mixture and the sulfur are kneaded through the second mixing step at a predetermined size; and a vulcanizing step of putting the second mixture cut through the cutting step into a cavity formed inside a forming mold and preparing a friction member by pressing while applying heat to the second mixture.

The present invention relates to a pad for preventing tire skidding and a manufacturing method thereof.

An adhesive layer coated with an adhesive is provided to be easily attached and usable to a vehicle tire, a mesh net is embedded in a friction member made of a large amount of butadiene rubber to improve durability, increase a pad driving life of around 700 Km to 2,000 Km or more, and minimize the pad from tearing or being damaged when the pad is removed from the tire. In addition, when the mesh net is made of a metal material, the mesh net is connected with a piezoelectric element to supply powder and a metal mesh net acts as a hot wire of the friction member to have a significant effect capable of preventing hardness caused by cooling, thereby minimizing the tire from skidding even on a snowy or icy road by increasing a friction force against the ground.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view of a pad for preventing tire skidding according to the present invention;

FIG. 2 is a cross-sectional view of the pad for preventing tire skidding of FIG. 1;

FIG. 3 is a graph showing performance values measured by using dynamic mechanical analysis with respect to Comparative Example and Examples 1 and 2 of the pad for preventing tire skidding; and

FIG. 4 is a flowchart of a manufacturing method of the pad for preventing tire skidding of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, a pad for preventing tire skidding according to an embodiment of the present invention will be described with reference to the accompanying drawings. The present invention may have various modifications and various embodiments, and specific embodiments will be illustrated in the drawings and described in detail in the specification. However, this does not limit the present invention to specific embodiments, and it should be understood that the present invention covers all the modifications, equivalents and replacements included within the idea and technical scope of the present invention. In describing each drawing, reference numerals refer to like elements. In the accompanying drawings, the dimensions of structures are illustrated to be enlarged compared to the actual size for clarity of the present invention.

Terms of first, second, and the like may be used for describing various components, but the components are not limited by the terms. The terms are used only for discriminating one component from the other component. For example, without departing from the scope of the present invention, a first component may be referred to as a second component, and similarly, the second component may be referred to as the first component.

The term used herein is used for the purpose of describing particular embodiments only and is not intended to be limiting. A singular form may include a plural form unless otherwise clearly indicated in the context. In the present application, it should be understood that the term “comprising” or “having” indicates that a feature, a number, a step, an operation, a component, a part or a combination thereof described in the specification is present, but does not exclude a possibility of presence or addition of one or more other features, numbers, steps, operations, components, parts or combinations thereof, in advance.

Unless defined otherwise, all terms to be used herein including technological or scientific terms have the same meaning as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

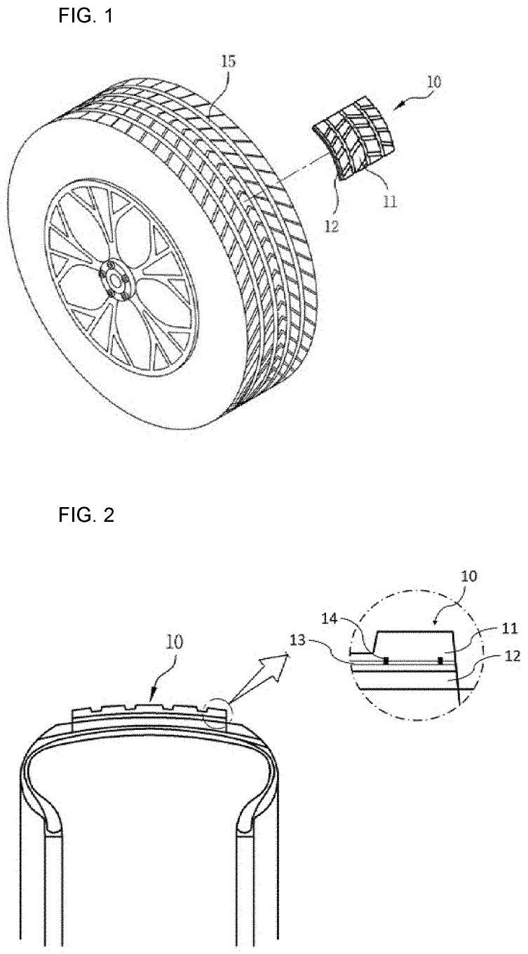

In FIGS. 1 and 2, a pad for preventing tire skidding is illustrated.

Referring to FIGS. 1 and 2, a pad 10 for preventing tire skidding includes a friction member 11 formed by mixing a raw material rubber containing butadiene rubber and a functional additive; an adhesive layer 12 coated with an adhesive on one side of the friction member 11 so that the friction member 11 may be adhered to a vehicle tire 15; a mesh net 13 embedded in the friction member; and a piezoelectric element 14 connected to the mesh net to supply power.

More specifically, the adhesive layer 12 is formed by coating the adhesive on one side of the friction member 11, and in order to more firmly adhere the friction member 11 to the surface of the rubber-made tire 15, it is preferable to use rubber-based adhesives.

The friction member 11 is attached to an outer peripheral surface of the vehicle tire 15, that is, the surface of the tire 15 with a tread by the adhesive layer 12, and a plurality of sliding prevention grooves is formed on the other surface to correspond to the tread of the tire 15.

Meanwhile, the friction member is formed by mixing the raw material rubber and the functional additive.

As the raw material rubber, butadiene rubber and additive rubber such as styrene butadiene copolymer rubber (SBR) or NR-polysopreme rubber (NR) are used. The butadiene rubber has a glass transition temperature (Tg) of about −60° C., which is relatively low, and has excellent durability.

At this time, when the raw material rubber is used in an amount of 80 wt % or less of butadiene rubber, the glass transition temperature (Tg) of the friction member 11 is −30° C. or higher, and thus, it is difficult to provide stable braking performance for roads in winter. Therefore, it is preferable that the raw material rubber is made of 80 wt % or more of the butadiene rubber and the rest of the additive rubber. In other words, the raw material rubber is made of 80 phr or more of butadiene rubber in a unit per hundred rubber (phr) based on 100 parts by weight of the raw material rubber. On the other hand, the raw material rubber may be made of only butadiene rubber, excluding the additive rubber.

In general, a winter road to be iced or snow-covered usually has a temperature of −30° C. or less, and in the case of the conventional tire 15, since the glass transition temperature (Tg) is −20° C. to −30° C., there is a problem in that a part in contact with the winter road is hardened to deteriorate the braking performance. However, since the glass transition temperature (Tg) is lower than that of a general tire 15 due to a large amount of butadiene rubber, even if the friction member 11 is in contact with the frozen road in winter, the friction member 11 is not hardened to provide more stable braking performance.

Meanwhile, the functional additive includes silica, carbon black, an adhesive, process oil, and stud powder. At this time, the friction member 11 includes 20 to 40 parts by weight of the silica, 20 to 40 parts by weight of the carbon black, 20 to 40 parts by weight of the adhesive, 5 parts by weight of the process oil, and 20 to 40 parts by weight of the stud powder with respect to 100 parts by weight of the raw material rubber.

When the silica in the friction member 11 is contained in an amount of 20 parts by weight or less, that is, 20 phr or less with respect to 100 parts by weight of the raw material rubber, the friction member 11 is easily hardened at a low temperature by increasing the hardness of the friction member 11, so that it is difficult to provide stable braking performance to low-temperature roads. In addition, when the silica in the friction member 11 is contained in an amount of 40 parts by weight or more, that is, 40 phr or more with respect to 100 parts by weight of the raw material rubber, it is difficult to disperse the silica in the materials of the raw material rubber, and thus, there is a disadvantage of increasing the cost and processing time required for manufacturing.

When the carbon black in the friction member 11 is contained in an amount of 20 parts by weight or less, that is, 20 phr or less with respect to 100 parts by weight of the raw material rubber, the strength and abrasion resistance of the friction member 11 are reduced. In addition, when the carbon black in the friction member 11 is contained in an amount of 40 parts by weight or more, that is, 40 phr or more with respect to 100 parts by weight of the raw material rubber, the manufacturing cost increases and the economy is deteriorated.

The process oil is mineral oil added to improve workability in the working process of the compounded rubber, and if the process oil in the friction member 11 is contained in an amount of more than 5 parts by weight, that is, more than 5 phr with respect to 100 parts by weight of the raw material rubber, the strength and abrasion resistance of the friction member 11 are reduced.

The adhesive is used as a plasticizer and provides predetermined adhesion to the friction member 11, and at least one of a phenolic resin, a terpene resin, or a rosin resin is used, and preferably, a C9 resin is used.

When the adhesive in the friction member 11 is contained in an amount of 20 parts by weight or less, that is, 20 phr or less with respect to 100 parts by weight of the raw material rubber, the adhesion of the friction member 11 to the road is low to cause skidding. In addition, if the adhesive in the friction member 11 is contained in an amount of 40 parts by weight or more, that is, 40 phr or more with respect to 100 parts by weight of the raw material rubber, the adhesion of the materials increases when mixed with other materials, and then, the materials adhere to a roll mill during the mixing operation, and thus, there is difficulty in working.

The stud powder is a material having a higher glass transition temperature (Tg) than that of butadiene rubber to improve the frictional force of the friction member 11 against the ground. The stud powder is applied with waste tires made of NR or SBR of which the glass transition temperature (Tg) is −20° C. to −30° C., and it is preferred that powder of crushed waste tires is applied.

When the friction member 11 comes into contact with a low-temperature road, the raw material rubber having a relatively low glass transition temperature is softened. However, since the stud powder is hardened due to the glass transition temperature higher than that of the butadiene rubber of the raw material rubber, when the friction member 11 is pressed against the road by the load of the vehicle, the stud powder protrudes from the surface of the friction member 11 to provide a stud function, thereby increasing the friction of the friction member 11 against the road.

In addition, when the friction member 11 comes into contact with a road at room temperature, the stud powder is softened due to the glass transition temperature or higher, and thus, the generation of noise and vibration is reduced even when the vehicle is driven at a high speed.

On the other hand, when the stud powder in the friction member 11 is contained in an amount of 20 parts by weight or less, that is, 20 phr or less with respect to 100 parts by weight of the raw material rubber, a stud function against the road is weakened and the friction of the friction member 11 against the road is reduced. In addition, when the stud powder in the friction member 11 is contained in an amount of 40 parts by weight or more, that is, 40 phr or more with respect to 100 parts by weight of the raw material rubber, the durability of the friction member 11 is reduced, so that the life expectancy is shortened.

In addition, since the mesh net is embedded in the friction member, the mesh net may prevent the pad from being damaged while driving, and prevent a part of the pad from being separated and bounced on other vehicles.

In addition, the mesh net may be made of a metal or synthetic resin material, and the metal mesh net may be connected with a piezoelectric element and used as a hot wire capable of preventing the hardness due to cooling of the friction member.

The friction member 11 configured as described above is manufactured by mixing the above-described materials and then injecting the mixture into a mold having a predetermined cavity and vulcanizing and molding the mixture, wherein it is preferred that the vulcanizing condition has a heating temperature of 160° C., a molding time of 10 minutes, and a pressure applied to the mixed material of 100 kg/cm².

On the other hand, a performance test was conducted on the pad 10 for preventing tire skidding according to the present invention. In Table 1 below, composition ratios for Comparative Example and Examples 1 and 2 were disclosed, respectively. A unit of each raw material is per hundred rubber (phr).

TABLE 1

| Raw material name | Comparative Example | Example 1 | Example2 |
|---|---|---|---|
| Butadiene rubber | 20.00 | 80.00 | 100.00 |
| SBR | 50.00 | 0.00 | 0.00 |
| NR | 30.00 | 20.00 | 0.00 |
| Stud powder (waste | 0.00 | 0.00 | 30.00 |
| tire rubber powder) | | | |
| Silica | 30.00 | 30.00 | 3.00 |
| Silane coupling agent | 3.00 | 3.00 | 3.00 |
| Carbon black | 30.00 | 30.00 | 30.00 |
| Process oil | 5.00 | 5.00 | 5.00 |
| Stearic Acid | 1.00 | 1.00 | 1.00 |
| C9 resin | 0.00 | 30.00 | 30.00 |
| Zinc oxide | 2.00 | 2.00 | 2.00 |
| CZ | 2.00 | 2.00 | 2.00 |
| Sulfur | 2.00 | 2.00 | 2.00 |
| Total | 175.00 | 185.00 | 235.00 |

Here, the butadiene rubber is a KBR01 product of Kumho Petrochemical Co., Ltd., the SBR is a SBR 1502 product of Kumho Petrochemical Co., Ltd., the NR is STR CV20 generally used in the related art, the waste tire rubber powder is a product of Yongbong Chemical Co., Ltd., wherein a particle size is 0.5 mm to 2.0 mm, the silica is a 2115 product of Rhodia Co., Ltd., the silane coupling agent is a SI69 product of Evonik Degussa Co., Ltd., the carbon black is an N330 product of Columbian carbon black Co., Ltd., the process oil is A#3 oil of Misung Chemical Co., Ltd., the C9 resin is a HIKOTAC product of Kolon Chemical Co., Ltd., and the remaining raw material is applied with additives that are commonly mixed in tire manufacturing. Comparative Example is a pad 10 manufactured according to a mixing ratio of a snow tire generally used in the related art, and Examples 1 and 2 are the pads 10 for preventing tire skidding according to the present invention.

The performance test results for strength, tensile strength, elongation, M100, resilience and abrasion with respect to Comparative Example and Examples 1 and 2 are shown in Table 2 below. Table 2 shows result values performed according to a standard performance test method generally used in the related art with respect to Comparative Example and Examples 1 and 2.

TABLE 2

| Test item | Comparative Example | Example 1 | Example2 |
|---|---|---|---|
| Hardness | 67 | 40 | 47 |
| Tensile strength (kg/cm²) | 193 | 163 | 123 |
| Elongation (%) | 720 | 2386 | 1646 |
| M100 (kg/cm²) | 50 | 30 | 29 |
| Resilience | 45 | 35 | 37 |
| Abrasion (g) | 0.180 | 0.187 | 0.203 |

Referring to Table 2, it can be seen that the hardness of Examples 1 and 2 containing a C9 resin and stud powder is lower by at least 20 than that of the pad 10 of Comparative Example manufactured at a mixing ratio of the conventional snow tire. This is because the C9 resin used excessively in Examples 1 and 2 acts as a plasticizer to significantly lower the hardness of the friction member 11. The pad 10 for preventing tire skidding according to the present invention, which contains a large amount of adhesive, maintains a predetermined adhesive force even on a road surface at a temperature higher than the glass transition temperature, thereby to prevent skidding on the road even on the ground at room temperature as well as at a low temperature.

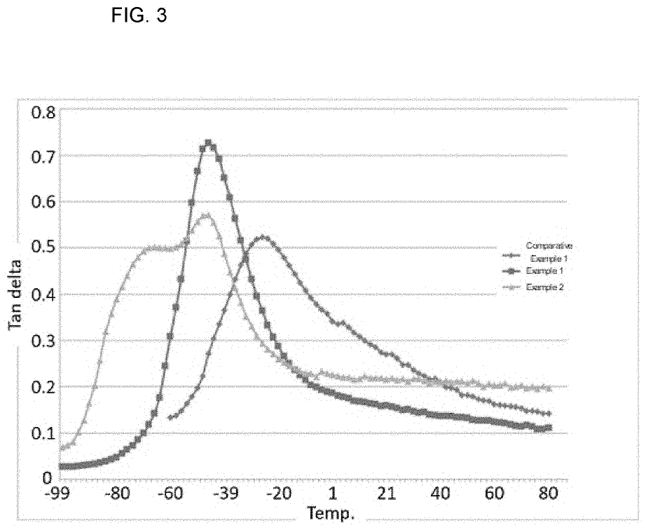

In addition, FIG. 3 shows a graph of the performance values measured using the dynamic mechanical analysis with respect to Comparative Example, and Examples 1 and 2. Table 3 below is a table summarizing the glass transition temperature values and tan delta values at low temperatures of Comparative Example, and Examples 1 and 2 based on the graph of FIG. 3.

TABLE 3

Test item

| | Comparative | | |
|---|---|---|---|
| Glass transition | Example | Example 1 | Example2 |
| temperature | −25° C. | −46° C. | −48° C., −65° C. |

| | | | | |
|---|---|---|---|---|
| −60° | C. | 0.133 | 0.308 | 0.499 |
| −30° | C. | 0.507 | 0.431 | 0.331 |
| −0° | C. | 0.341 | 0.185 | 0.225 |

In the dynamic mechanical analysis, the mechanical analysis of a material is measured as a function of temperature, frequency, and vibration. When a periodic external force is applied to the sample, a periodic stress is generated in the sample, and the sample reacts to this stress, resulting in a corresponding deformation. The mechanical modulus is determined from the stress and deformation at this time, and a shear modulus (G) and a Young's modulus (E) are measured according to a stress shape to be applied. In other words, a phase difference occurs according to a stress (usually referred to as sinusoidal stress) that is changed periodically by a time delay due to a viscoelastic property of the material. The modulus dynamically measured in consideration of this phase difference is described as a storage modulus (G′) and a loss modulus (G″). G′ is a direct result of the DMA measurement, which is an in-phase response of the sample with periodic stress and corresponds to the reversible elasticity of the sample. The virtual component G″ is a phase shifted response up to 900 and corresponds to mechanical energy that is converted into heat and irreversibly lost. The tan δ of this phase difference is a loss factor and is used to measure the damping behavior of the material.

Referring to FIG. 3 and Table 3, the glass transition temperatures of Examples 1 and 2 were lower than that of Comparative Example, and in the case of Example 2, the glass transition temperature indicates two values of −48° C. and −65° C. In Example 2, since the raw material rubber and the stud powder have different glass transition temperatures to have two glass transition temperatures, respectively.

The graph of FIG. 3, that is, a tan delta value of DMA is an index indicating a hysteresis value occurring at each temperature, and a high tan delta value indicates that the elasticity of the rubber is maintained in the temperature range. Referring to the graph of FIG. 3, when it is seen that the tan delta values at −60° C. of Examples 1 and 2 are higher than that of Comparative Example, the pad 10 for preventing tire skidding according to the present invention is not hardened when being in contact with a low-temperature road to provide stable braking performance.

As described above, the pad 10 for preventing tire skidding according to the present invention is provided with the adhesive layer 12 coated with the adhesive to be easily attached and useable to the vehicle tire. Since the pad 10 is made of a large amount of butadiene rubber, there is an advantage of preventing the tire from skidding even on snowy or icy roads by increasing the friction force against the ground.

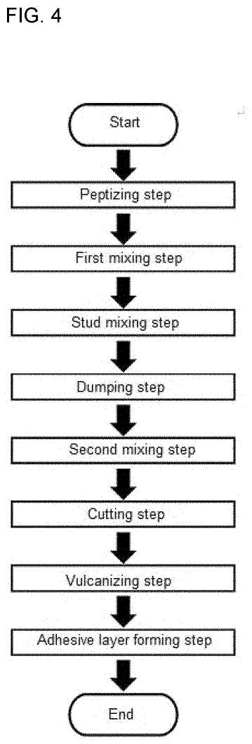

On the other hand, FIG. 4 illustrates a flowchart of a manufacturing method of the pad for preventing tire skidding according to the present invention.

Referring to FIG. 4, the manufacturing method of the pad for preventing tire skidding comprises a peptizing step (S101), a first mixing step (S102), a stud mixing step (S103), a dumping step (S104), a second mixing step (S105), a cutting step (S106), a vulcanizing step (S107), and an adhesive layer forming step (S108).

The peptizing step (S101) is a step in which a raw material rubber containing butadiene rubber is peptized at a predetermined temperature. At this time, as the raw material rubber, butadiene rubber and additive rubber such as styrene butadiene copolymer rubber (SBR) or NR-polysopreme rubber (NR) are used as described above. At this time, it is preferable that the raw material rubber consists of 80 wt % or more of the butadiene rubber and the rest of the additive rubber. In other words, the raw material rubber consists of 80 phr or more of butadiene rubber in a unit per hundred rubber (phr) based on 100 parts by weight of the raw material rubber. On the other hand, the raw material rubber may be made of only butadiene rubber, excluding the additive rubber.

At this time, since the diene-based rubber has a relatively low peptizing effect, it is preferable that the raw material rubber is peptized at a temperature of 60° C. or less for 1 to 2 minutes in the peptizing step (S101). Herein, the peptizing is also referred to as a lowering operation, which refers to an operation in which depolymerization is caused by applying shearing force and heat to the rubber, and the rubber is softened to become a uniform plasticizing state.

The first mixing step (S102) is a step of kneading the raw material rubber and the functional additive using a kneader, after the peptizing step (S101). In this case, since the kneader is a kneading means generally used in the related art for kneading a rubber material, a detailed description thereof will be omitted.

The functional additive includes silica, carbon black and an adhesive, but preferably consists of 20 to 40 parts by weight of the silica, 20 to 40 parts by weight of the carbon black, and 20 to 40 parts by weight of the adhesive with respect to 100 parts by weight of the raw material rubber. In addition, a silane coupling agent, process oil, stearic acid, and zinc oxide may be added as the functional additive.

In addition, in the first mixing step (S102), kneading is started while the raw material rubber and the functional additive are heated to a predetermined set temperature, but the temperature of the raw material rubber and the functional additive is heated to be increased and mixed as time elapses from the start of kneading. In this case, it is preferable that the set temperature is 120° C., the temperature of the raw material rubber and the functional additive at the ending time of kneading is 160° C., and the kneading time of the raw material rubber and the functional additive is 9 minutes or less. As described above, in the first mixing step (S102), since the temperature of the raw material rubber and the functional additive is increased over time after the start of the kneading, there are advantages of preventing the butadiene rubber and the functional additive from being deteriorated and improving the kneading efficiency.

The stud mixing step (S103) is a step of kneading stud powder having a higher glass transition temperature (Tg) than that of the butadiene rubber to a first mixture in which the raw material rubber and the functional additive are kneaded through the first mixing step (S102). At this time, the stud powder is a crushed waste tire, and it is preferable that the first mixture and the stud powder are heated to a temperature of 140° C. or less and kneaded for a period of 2 to 3 minutes. At this time, 20 to 40 parts by weight of the stud powder is kneaded into the first mixture with respect to 100 parts by weight of the raw material rubber.

Since the stud powder consisting of the waste tire has a larger particle size than other raw materials, materials such as carbon or silica may interfere with binding with the raw material rubber, but when the first mixing step (S102) is completed, the silane reaction between silica and a polymer of the first mixture is completed, and thus, after the first mixing step (S102), the stud powder is kneaded with the first mixture.

The dumping step (S104) is a step of dumping the first mixture in which the raw material rubber and the functional additive are kneaded through the first mixing step (S102) from the kneader. An operator draws out the first mixture in which the stud powder is kneaded from the kneader, and leaves and then stabilizes the first mixture drawn out from the kneader at room temperature for about 24 hours.

The second mixing step (S105) is a step of kneading sulfur into the first mixture, after the dumping step (S104). Here, it is preferable that the operator kneads not only sulfur but also an accelerator into the first mixture. In the second mixing step (S105), the first mixture containing sulfur and the accelerator is heated to a temperature of 120° C. or less and kneaded for a period of 3 minutes or less. At this time, a sealed kneader or an open roll may be used.

The cutting step (S106) is a step of cutting the second mixture kneaded with the first mixture and sulfur through the second mixing step (S105) to predetermined sizes. First, the second mixture is drawn out from the kneader, and then, a synthetic resin-made mesh net or a piezoelectric element is connected with the second mixture between open rolls, that is, pressure rollers spaced apart from each other to be processed into a sheet type having a predetermined thickness by passing through a metal mesh net capable of supplying power simultaneously. The second mixture processed into the sheet type is cut into predetermined sizes. At this time, the second mixture is preferably cut to have an amount suitable for manufacturing one pad for preventing tire skidding, that is, a size corresponding to a cavity of a forming mold to be described below.

The vulcanizing step (S107) is a step of putting the second mixture cut through the cutting step (S106) into a cavity formed inside the forming mold and preparing the friction member 11 by pressing while applying heat to the second mixture. At this time, the second mixture is heated to a temperature of 160° C., and pressed at a pressure of 100 kg/cm² for 10 minutes to prepare the friction member 11. When the vulcanizing step (S107) is completed, the friction member 11 is demolded from the forming mold to check whether a crack or bubble phenomenon occurs in the friction member 11, and if the crack or bubble phenomenon occurs in the friction member 11, the friction member 11 is discarded. In addition, the operator may form a plurality of sliding prevention grooves corresponding to a tread of the tire on the side surface of the friction member 11 demolded from the forming mold.

The adhesive layer forming step (S108) is a step of forming the adhesive layer 12 on one side of the friction member 11, after the vulcanizing step (S107). The operator applies an adhesive such as a cyanoacrylate-based chemical adhesive to one side of the friction member 11 to form the adhesive layer 12, and may attach a release paper adhered to the adhesive layer 12 to protect the adhesive layer 12 on the surface of the adhesive layer 12.

The manufacturing method of the pad for preventing tire skidding according to the present invention described above has an advantage of improving the workability of manufacturing the pad for preventing tire skidding by more efficiently kneading the raw material rubber containing a large amount of butadiene rubber, the functional additive, and the stud powder through a multi-stage kneading process.

The description of the presented embodiments is provided so that those skilled in the art of the present invention can use or implement the present invention. Various modifications of the embodiments will be apparent to those skilled in the art and general principles defined herein can be applied to other embodiments without departing from the scope of the present invention. Therefore, the present invention is not limited to the embodiments presented herein, but should be interpreted within the widest range which is coherent with the principles and new features presented herein.

What is claimed is:

1. A pad for preventing tire skidding comprising:
a friction member formed by mixing a raw material rubber containing 80 wt % or more of butadiene rubber and a functional additive; and
an adhesive layer coated with an adhesive on one side of the friction member so that the friction member is able to be adhered to a vehicle tire,
wherein the functional additive consists of silica, carbon black, an adhesive made of C9 resin, and stud powder made of waste tires crushed to have a higher glass transition temperature (Tg) than that of butadiene rubber to improve the frictional force of the friction member against the ground, and the friction member includes 20 to 40 parts by weight of the silica, 20 to 40 parts by weight of the carbon black, 20 to 40 parts by weight of the adhesive, and 20 to 40 parts by weight of the stud powder with respect to 100 parts by weight of the raw material rubber.

2. The pad for preventing tire skidding of claim 1, further comprising:
a mesh net embedded in the friction member and made of a metal or a synthetic resin.

3. The pad for preventing tire skidding of claim 2, further comprising:
a piezoelectric element connected to the mesh net to supply power and capable of acting as a hot wire in which the mesh net is embedded in the friction member.

4. A manufacturing method of a pad for preventing tire skidding comprising:
a peptizing step of peptizing a raw material rubber containing 80 wt % or more of butadiene rubber at a temperature of 60° C. or less for 1 to 2 minutes;
a first mixing step of heating and mixing the raw material rubber with a functional additive consisting of 20 to 40 parts by weight of silica, 20 to 40 parts by weight of carbon black, and 20 to 40 parts by weight of an adhesive with respect to 100 parts by weight of the raw material rubber using a kneader while increasing the temperature as time elapses from the starting time of the kneading, after the peptizing step;
a dumping step of dumping a first mixture in which the raw material rubber and the functional additive are kneaded through the first mixing step from the kneader and leaving and stabilizing the dumped first mixture at room temperature;
a second mixing step of kneading sulfur into the first mixture, after the dumping step;
a cutting step of cutting the second mixture kneaded with the first mixture and sulfur through the second mixing step in a predetermined size;
a vulcanizing step of putting the second mixture cut through the cutting step into a cavity formed inside a forming mold and preparing a friction member by pressing while applying heat to the second mixture; and
a stud mixing step of kneading the first mixture and stud powder into the first mixture for 2 to 3 minutes by heating the first mixture and the stud powder at a temperature of 140° C. or less to have a higher glass transition temperature (Tg) than that of the butadiene rubber, between the first mixing step and the dumping step.

5. The manufacturing method of the pad for preventing tire skidding of claim 4, wherein in the first mixing step, the set temperature is 120° C., the temperature of the raw material rubber and the functional additive at the ending time of kneading is 160° C., and the kneading time of the raw material rubber and the functional additive is 9 minutes or less.

6. The manufacturing method of the pad for preventing tire skidding of claim 4, wherein in the cutting step, the second mixture is drawn out from the kneader, and then, a synthetic resin-made mesh net or a piezoelectric element is connected with the second mixture between open rolls, that is, pressure rollers spaced apart from each other to be processed into a sheet type having a predetermined thickness by passing through a metal mesh net capable of supplying power simultaneously.
